(19) United States
(12) Patent Application Publication
(10) Pub. No.: US 2020/0174401 A1
(43) Pub. Date: Jun. 4, 2020

(54) DEVELOPER SUPPLYING APPARATUS, DEVELOPING APPARATUS, CARTRIDGE, AND IMAGE FORMING APPARATUS

(71) Applicant: CANON KABUSHIKI KAISHA, Tokyo (JP)

(72) Inventors: Satoru Harada, Suntou-gun (JP); Akinobu Hirayama, Susono-shi (JP)

(21) Appl. No.: 16/693,875

(22) Filed: Nov. 25, 2019

(30) Foreign Application Priority Data
Nov. 29, 2018 (JP) 2018-223906

(51) Int. Cl. G03G 15/10; G03G 15/08

(52) U.S. Cl. CPC G03G 15/104; G03G 15/0872; G03G 15/0877; G03G 15/0891

(57) ABSTRACT

A developer supplying apparatus, including: a developing frame having a developer storage chamber and an opening; a transport member which transports a developer from an inner side toward an opening side; and a drive transmitting member which moves the transport member by a driving force, wherein the drive transmitting member includes: a rotating shaft portion; a driven shaft portion which orbits around the rotating shaft portion; and a connecting portion which connects the rotating shaft portion and the driven shaft portion, and wherein the transport member includes: a transport portion having a first end portion on the opening side and a second end portion which is coupled to the driven shaft portion on the inner side; and a contact portion configured such that one end thereof is coupled to the transport portion and another end thereof is capable to contact with the developing frame.

### BACKGROUND OF THE INVENTION

### Field of the Invention

The present invention relates to a process cartridge and to a developer supplying apparatus in an image forming apparatus using the process cartridge.

### Description of the Related Art

In an electrophotographic image forming apparatus (hereinafter, also simply referred to as an “image forming apparatus”), an electrophotographic photoreceptor that is generally of a drum type or, in other words, a photosensitive drum as an image bearing member is uniformly charged. Next, the charged photosensitive drum is selectively exposed to form an electrostatic latent image (an electrostatic image) on the photosensitive drum. Next, the electrostatic latent image formed on the photosensitive drum is developed as a toner image with toner as a developer. Subsequently, image recording is performed by transferring the toner image formed on the photosensitive drum to a recording material such as a sheet of recording paper or a plastic sheet and further applying heat and pressure to the toner image having been transferred onto the recording material to fix the toner image to the recording material.

Such an image forming apparatus generally requires replenishment of toner and maintenance of various process portion. In order to facilitate such replenishment of toner and maintenance, process cartridges are being put to practical use which are made by collectively configuring a photosensitive drum, charging portion, developing device, cleaning portion, and the like inside a frame body and which are attachable to and detachable from an image forming apparatus main body.

In this case, a process cartridge refers to a cartridge which integrates a photosensitive drum and process portion that acts on the photosensitive drum and which is attachably and detachably mounted to an image forming apparatus main body. For example, a photosensitive drum and at least one of developing device, charging portion, and cleaning portion as the process portion are integrated to create a cartridge. In addition, an image forming apparatus refers to an apparatus that forms an image on a recording medium using an electrophotographic image forming system. Examples of an image forming apparatus include an electrophotographic copier, an electrophotographic printer (such as an LED printer or a laser beam printer), a facsimile device, and a word processor.

According to the process cartridge system, since a user can personally perform maintenance of the apparatus, operability can be dramatically improved and, consequently, an image forming apparatus with superior usability can be provided. For this reason, the process cartridge system is widely used in image forming apparatuses.

In the process cartridge, a developing device constituting a developing apparatus and a transport member being developer transporting member as means to transport toner inside a toner container are arranged inside the toner container.

In addition, as a mode of the toner feeding member, a mode of transporting toner by moving the transport member in a reciprocating manner with drive input of a drive member is being implemented (Japanese Patent Application Laid-open No. H04-21879).

### SUMMARY OF THE INVENTION

However, during toner transport inside the toner container described above, since the drive member is positioned on a downstream side in a transport direction, a state where the toner may come into contact with a sliding portion between the drive member and the transport member is to be continuously maintained over an entire lifespan of the cartridge. Therefore, there is a risk that the toner is continuously subjected to stress until a latter half of the lifespan of the cartridge and may cause printed image quality to decline.

An object of the present invention is to provide a developer supplying apparatus in which there is little contact between toner and a rubbing portion in a latter half of a lifespan of a cartridge and which is capable of transporting toner in an efficient manner as a toner transport method with reduced stress on toner throughout the entire lifespan of the cartridge.

In order to achieve the object described above, a developer supplying apparatus according to the present invention includes:

a developing frame having an opening and a developer storage chamber which communicates with the opening and which stores a developer;

a transport member which is provided in the developer storage chamber and which transports and supplies the developer from an inner side that is distant from the opening toward an opening side that is close to the opening; and

a drive transmitting member which is connected to the transport member and which moves the transport member by transmitting a driving force to the transport member,

wherein the drive transmitting member includes:
a rotatable rotating shaft portion;
a driven shaft portion which orbits around the rotating shaft portion with the rotating shaft portion as a center of rotation; and
a connecting portion which connects the rotating shaft portion and the driven shaft portion, and

wherein the transport member includes:
a transport portion having a first end portion positioned on the opening side and a second end portion which is positioned on the inner side and which is coupled to the driven shaft portion; and
a contact portion configured such that one end thereof is coupled to the transport portion and another end thereof is capable of coming into contact with the developing frame.

In order to achieve the object described above, a developing apparatus according to the present invention includes:

the developer supplying apparatus as described above;

a developer bearing member for bearing a developer supplied from the developer supplying apparatus; and

a developing blade for restricting a toner layer borne on the developer bearing member.

In order to achieve the object described above, a cartridge according to the present invention includes:

the developing apparatus as described above; and

an image bearing member on which an electrostatic latent image is to be formed,

wherein the cartridge is attachable to and detachable from an apparatus main body of an image forming apparatus.

Furthermore, in order to achieve the object described above, an image forming apparatus according to the present invention includes:

the cartridge as described above; and

an apparatus main body to which the cartridge is attachable and from which the cartridge is detachable.

According to the present invention, by increasing an amount of a developer which is transported without being subjected to rubbing and which is supplied from an opening to a developing portion, a developer transport method with reduced stress on the developer can be provided.

Further features of the present invention will become apparent from the following description of exemplary embodiments with reference to the attached drawings.

### BRIEF DESCRIPTION OF THE DRAWINGS

FIG. 1 is a sectional view showing a developer storage container according to a first embodiment;

FIG. 2 is a sectional view of an apparatus main body of an image forming apparatus and a process cartridge according to the first embodiment;

FIG. 3 is a sectional view of the process cartridge according to the first embodiment;

FIG. 4 is an exploded view of the process cartridge according to the first embodiment;

FIG. 5 is an exploded view of the process cartridge according to the first embodiment;

FIG. 6 is an exploded view of the developer storage container according to the first embodiment;

FIGS. 7A to 7D are operation diagrams according to the first embodiment when a developer inside the developer storage container is not taken into consideration;

FIGS. 8A to 8C are operation diagrams during transport when a developer capacity inside the developer storage container is larger than a predetermined capacity; and

FIGS. 9A to 9D are operation diagrams during transport when a developer capacity inside the developer storage container is smaller than the predetermined capacity.

### DESCRIPTION OF THE EMBODIMENTS

Hereinafter, a description will be given, with reference to the drawings, of embodiments (examples) of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments.

### First Embodiment

Hereinafter, an embodiment of the present invention will be described in detail with reference to the drawings.

It should be noted that a rotational axis direction of a photosensitive drum is assumed to be a longitudinal direction, a direction of gravitational force is assumed to be a vertical direction, and a direction perpendicular to both the longitudinal direction and the vertical direction is assumed to be a transport direction of toner that is a developer. In addition, in the longitudinal direction, a side where a photosensitive drum receives a driving force from an image forming apparatus main body is assumed to be a driving side and an opposite side thereof is assumed to be a non-driving side.

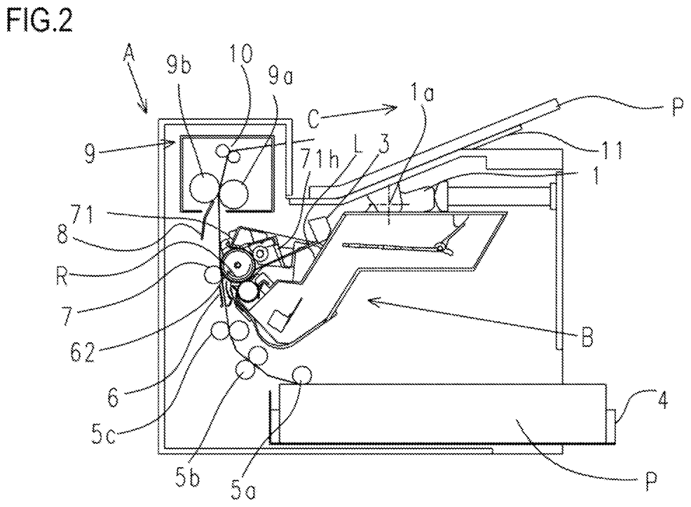

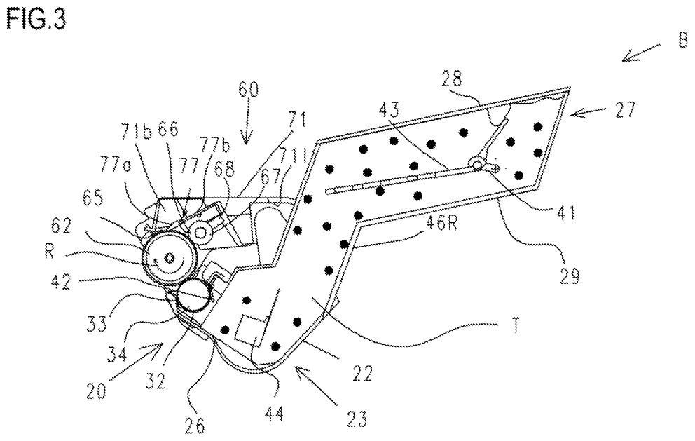

An overall configuration and an image forming process will be described with reference to FIGS. 2 and 3. FIG. 2 is a sectional view of an image forming apparatus main body of an image forming apparatus (hereinafter, described as an apparatus main body A) and a process cartridge (hereinafter, described as a cartridge B) according to an embodiment of the present invention. FIG. 3 is a sectional view of the cartridge B. In this case, the apparatus main body A refers to a portion excluding the cartridge B of the image forming apparatus.

Overall Configuration of Electrophotographic Image Forming Apparatus

The electrophotographic image forming apparatus shown in FIG. 2 is a laser beam printer which uses electrophotographic technology and in which the cartridge B is configured to be attachable to and detachable from the apparatus main body A. When the cartridge B is mounted to the apparatus main body A, an exposing apparatus 3 (a laser scanner unit) for forming a latent image on a photosensitive drum 62 as an image bearing member of the cartridge B is arranged. In addition, a sheet tray 4 housing a recording medium (hereinafter, described as a sheet material P) that is an image formation object is arranged below the cartridge B.

Furthermore, in the apparatus main body A, a pickup roller 5a, a feeding roller pair 5b, a transport roller pair 5c, a transfer guide 6, a transfer roller 7, a transport guide 8, a fixing apparatus 9, a discharge roller pair 10, a discharge tray 11, and the like are sequentially arranged in a transport direction D of the sheet material P. The fixing apparatus 9 is constituted by a heating roller 9a and a pressure roller 9b.

Image Forming Process

Next, an outline of the image forming process will be described. On the basis of a print start signal, the photosensitive drum (hereinafter, described as a drum 62) is rotationally driven in a direction of an arrow R at a predetermined circumferential speed (process speed). A charging roller 66 as charging portion to which a bias voltage is applied comes into contact with an outer circumferential surface of the drum 62 and uniformly charges the outer circumferential surface of the drum 62.

The exposing apparatus 3 outputs laser light L in accordance with image information. The laser light L passes through a laser opening 71H provided on a cleaning frame body 71 of the cartridge B and scans and exposes the outer circumferential surface of the drum 62. Accordingly, an electrostatic latent image corresponding to the image information is formed on the outer circumferential surface of the drum 62.

Meanwhile, as shown in FIG. 3, in a developing unit 20 as a developing apparatus, toner T inside a toner supply chamber 26 as a developing chamber is stirred and transported by a developing chamber transport member 44. Due to a magnetic force of a magnet roller 34 (a stationary magnet), the toner T is borne on a surface of a developing roller 32, and a layer thickness of the toner T on a circumferential surface of the developing roller 32 as a developer bearing member is restricted while the toner T is being frictionally charged by a developing blade 42. Subsequently, the toner T with the restricted layer thickness is developed on the drum 62 in accordance with the electrostatic latent image and creates a visible image in the form of a toner image.

In addition, as shown in FIG. 2, at a same timing as output of the laser light L, the sheet material P housed in a lower part of the apparatus main body A is fed from the sheet tray 4 by the pickup roller 5a, the feeding roller pair 5b, and the transport roller pair 5c. Subsequently, the sheet material P passes by the transfer guide 6 and is supplied to a transfer position between the drum 62 and the transfer roller 7. At the transfer position, the toner image is sequentially transferred from the drum 62 to the sheet material P.

The sheet material P onto which the toner image has been transferred is separated from the drum 62 and transported to the fixing apparatus 9 along the transport guide 8. The sheet material P then passes a nip portion between the heating roller 9a and the pressure roller 9b which constitute the fixing apparatus 9. The sheet material P is subjected to a pressure and heat fixing process by the nip portion and the toner image is fixed onto the sheet material P. After being subjected to the toner image fixing process, the sheet material P is transported to the discharge roller pair 10 and discharged to the discharge tray 11.

Meanwhile, as shown in FIG. 3, residual toner on the outer circumferential surface of the drum 62 after the transfer of toner is removed by a cleaning member 77 and the drum 62 is once again used in an image forming process. The toner removed from the drum 62 is stored in a waste toner chamber 71b of a cleaning unit 60 as a frame body that includes the photosensitive drum 62.

In the description provided above, the charging roller 66, the developing roller 32, the transfer roller 7, and the cleaning member 77 are processing portion that act on the drum 62.

Overall Configuration of Cartridge

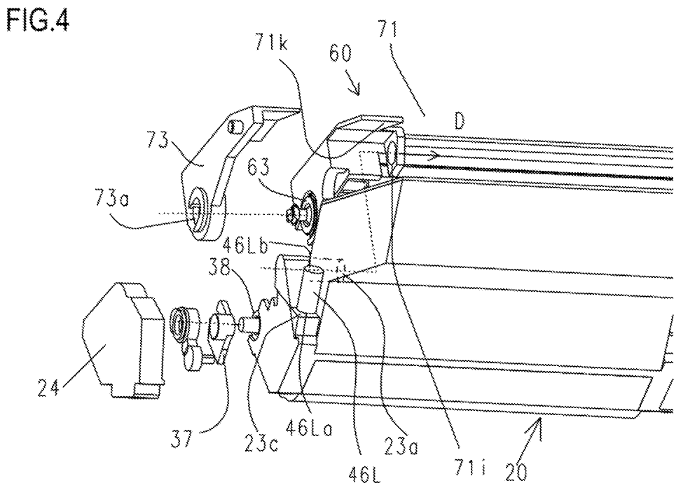

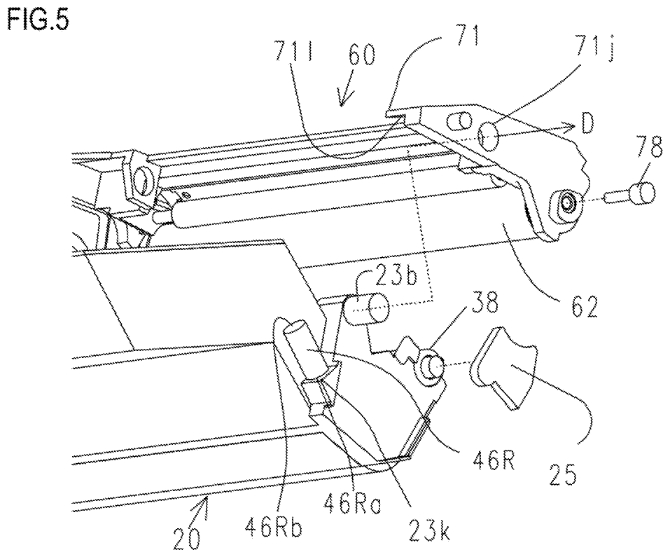

Next, an overall configuration of the cartridge B will be described with reference to FIGS. 3 to 5. FIG. 3 is a sectional view of the cartridge B and FIGS. 4 and 5 are perspective views illustrating a configuration of the cartridge B. It should be noted that screws used when joining the respective parts will be omitted in the description of the present embodiment.

The cartridge B includes the cleaning unit 60 and the developing unit 20.

Generally, a process cartridge is as described earlier and, in the present invention, a process cartridge includes at least the developing unit 20 according to the present invention.

As shown in FIG. 3, the cleaning unit 60 includes the drum 62, the charging roller 66, the cleaning member 77, and the cleaning frame body 71 which supports the drum 62, the charging roller 66, and the cleaning member 77. In the cleaning unit 60, the charging roller 66 and the cleaning member 77 are respectively arranged in contact with an outer circumferential surface of the drum 62. The cleaning member 77 includes a rubber blade 77a that is a blade-like elastic member formed by rubber as an elastic material and a supporting member 77b which supports the rubber blade 77a. The rubber blade 77a is in contact with the drum 62 in a counter direction with respect to a rotation direction of the drum 62. In other words, the rubber blade 77a is in contact with the drum 62 so that a tip portion of the rubber blade 77a is oriented toward an upstream side in the rotation direction of the drum 62.

As shown in FIG. 3, waste toner having been removed from the surface of the drum 62 by the cleaning member 77 is stored in a waste toner chamber 71b formed by the cleaning frame body 71 and the cleaning member 77. In addition, a squeegee 65 for preventing leakage of waste toner from the cleaning frame body 71 is provided at an edge portion of the cleaning frame body 71 so as to come into contact with the drum 62.

The drum 62 is rotationally driven in the direction of the arrow R in FIG. 3 in accordance with an image forming operation by receiving a driving force from a main body drive motor (not illustrated) which is a drive source. At both end portions in the longitudinal direction (approximately parallel to the rotational axis direction of the drum 62) of the cleaning frame body 71, the charging roller 66 is rotatably attached to the cleaning unit 60 via a charging roller bearing 67. The charging roller 66 comes into pressure contact with the drum 62 as the charging roller bearing 67 is pressurized toward the drum 62 by a biasing member 68. The charging roller 66 is driven to rotate so as to follow a rotation of the drum 62.

As shown in FIG. 3, the developing unit 20 includes the developing roller 32, a developer container 23 which supports the developing roller 32, the developing blade 42, and the like. A magnet roller 34 is provided inside the developing roller 32. In addition, the developing blade 42 for restricting a toner layer on the developing roller 32 is arranged in the developing unit 20. As shown in FIGS. 4 and 5, an interval holding member 38 is attached to both end portions of the developing roller 32 and, due to the interval holding member 38 and the drum 62 coming into contact with each other, the developing roller 32 is held such that a minute gap exists between the developing roller 32 and the drum 62. In addition, as shown in FIG. 3, a blow-out prevention sheet 33 for preventing toner from leaking from the developing unit 20 is provided at an edge portion of a bottom member 22 so as to come into contact with the developing roller 32. Furthermore, a transport member 43 is provided in a toner chamber 27 formed by the developer container 23 as a developing frame and the bottom member 22. The transport member 43 transports toner as a developer stored in the toner chamber 27 which is a developer storage chamber to the toner supply chamber 26.

As shown in FIGS. 4 and 5, the cartridge B is constructed by uniting the cleaning unit 60 and the developing unit 20. As described above, the cleaning unit 60 is provided with the cleaning frame body 71, the drum 62, and a drum bearing 73 and a drum shaft 78 for rotatably supporting the drum 62. As shown in FIG. 4, on the driving side, a driving-side drum flange 63 provided on the driving side of the drum 62 is rotatably supported by a hole portion 73a of the drum bearing 73. On the other hand, as shown in FIG. 5, on a non-driving side, the drum shaft 78 having been fitted with pressure into a hole portion 71c provided in the cleaning frame body 71 is configured so as to rotatably support a hole portion (not illustrated) of a non-driving-side drum flange 64.

As shown in FIG. 3, the developing unit 20 is constituted by the bottom member 22, the developer container 23, the developing blade 42, the developing roller 32, and the like. In addition, as shown in FIGS. 4 and 5, the developing roller 32 is rotatably attached to the developer container 23 by bearing members 25 and 37 provided at both ends.

Joining of the cleaning unit 60 and the developing unit 20 will now be described with reference to FIGS. 4 and 5. When joining the cleaning unit 60 and the developing unit 20 to each other, first, a center of a developing first supporting boss 23a of the developer container 23 is positioned with respect to a driving-side first hanging hole 71i of the cleaning frame body 71 and a center of a developing second supporting boss 23b is positioned with respect to a non-driving-side second hanging hole 71j. Specifically, by moving the developing unit 20 in a direction of an arrow D, the developing first supporting boss 23a and the developing second supporting boss 23b are fitted into the first hanging hole 71i and the second hanging hole 71j. Accordingly, the developing unit 20 is rotatably coupled to the cleaning unit 60. Subsequently, the drum bearing 73 is assembled to the cleaning unit 60 to construct the cartridge B.

In addition, a first end portion 46La of a driving-side biasing member 46L is fixed to a surface 23c of the developer container 23, and a second end portion 46Lb comes into contact with a surface 71k constituting a part of the cleaning unit. Furthermore, a first end portion 46Ra of a non-driving-side biasing member 46R is fixed to a surface 23k of the developer container 23, and a second end portion 46Rb comes into contact with a surface 71l constituting a part of the cleaning unit.

The present embodiment adopts a configuration in which the driving-side biasing member 46L and the non-driving-side biasing member 46R are formed of compression springs, and by biasing the developing unit 20 toward the cleaning unit 60 with a biasing force of the springs, the developing roller 32 is reliably pressed in the direction of the drum 62. In addition, due to the interval holding member 38 attached to both end portions of the developing roller 32, the developing roller 32 is held at a predetermined interval from the drum 62.

It should be noted that the driving-side biasing member 46L and the non-driving-side biasing member 46R are displayed as cylinders in order to illustrate configurations thereof in a simplified manner.

Toner Chamber Transport Configuration

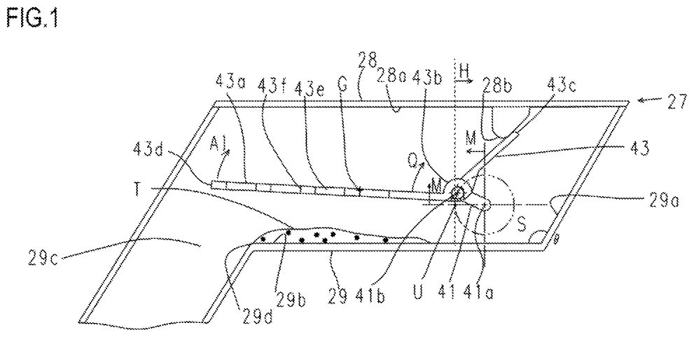

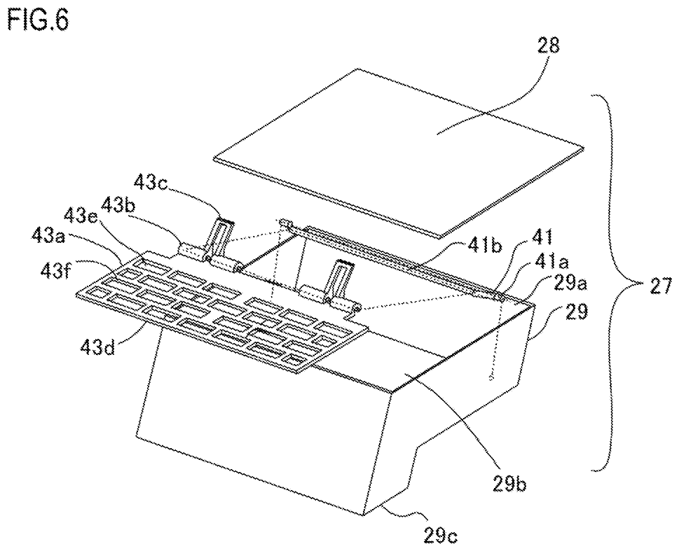

Next, a transport configuration of the toner chamber that is a developer storage chamber will be described using the exploded view shown in FIG. 6 and the sectional view shown in FIG. 1. As shown in FIG. 6, the toner chamber 27 includes a lid portion 28 and a container portion 29, and the container portion 29 has, at one end in the transport direction, an opening 29c communicating with the toner supply chamber 26. In addition, the container portion 29 has a side surface 29a at another end in the transport direction and a bottom surface 29b. In this case, a direction from an inner side where the side surface 29a at a position distant from the opening 29c described above is provided toward an opening side that is close to the opening 29c corresponds to a transport direction of toner inside the toner chamber 27 in the present embodiment. Hereinafter, the one end in the transport direction that is an opening side close to the opening 29c will be described as the one end and the other end in the transport direction as an inner side where the side surface 29a at a position distant from the opening 29c is provided will be described as the other end.

A crank member 41 as a drive transmitting member and the transport member 43 are housed inside the toner chamber 27.

The crank member 41 has a rotating shaft portion 41a and a driven shaft portion 41b, and both ends of the driven shaft portion 41b are coupled to the rotating shaft portion 41a by connecting portions. In addition, the crank member 41 is positioned on an inner side in a vicinity of the other end-side surface 29a, assumes an attitude in which the rotating shaft portion 41a is approximately parallel to the longitudinal direction, and is rotatable around the rotating shaft portion 41a.

The transport member 43 is provided with a transport portion 43a, a sliding portion 43b, and a contact portion 43c which are positioned in an order of the transport portion 43a, the sliding portion 43b, and the contact portion 43c from the one end side.

The transport portion 43a with a flat plate shape has a free end 43d that is a first end portion on the one end side and the sliding portion 43b as a second end portion to be connected to the driven shaft portion 41b on the other end side, and the transport portion 43a is integrally formed with the contact portion 43c. In addition, a plurality of through-holes 43e and a rib 43f are provided on a flat plate surface of the transport portion 43a. The contact portion 43c is provided further toward the other end side than the sliding portion 43b so that a predetermined angle is formed with respect to the transport portion 43a, and the contact portion 43c is positioned above the sliding portion 43b in the vertical direction in an attitude during use.

Furthermore, as shown in FIG. 1, the other end-side surface 29a of the toner chamber is an inclined surface that is continuous to the bottom surface 29b when viewed from a direction perpendicular to the toner transport direction described earlier, and the other end-side surface 29a is provided so that an angle formed between the bottom surface 29b is an obtuse angle θ. Accordingly, capacity can be increased as compared to a case where the side surface 29a is perpendicular to the bottom surface 29b.

In addition, the driven shaft portion 41b moves in accordance with a rotation of the rotating shaft portion 41a, orbits around the rotating shaft portion 41a, and traces a rotation locus S. The lid portion 28 has an intra-container top surface 28a facing downward in the vertical direction as a top surface in an inner wall surface of the developing frame having the toner chamber in an attitude during use. Furthermore, the intra-container top surface 28a is provided with a contacted portion 28b as a projected portion that protrudes toward the inside of the toner chamber in a region H which is further toward the other end side than a point U closest to the one end side and which is outside the locus S traced by the driven shaft portion 41b in the crank member 41 that is a drive transmitting member. In the toner chamber transport configuration described above, while the toner chamber 27 adopts a mode in which the lid portion 28 and the container portion 29 are divided in the present embodiment, other division methods or an undivided configuration can also be implemented.

The shapes and positions of the contacted portion 28b and the contact portion 43c are merely examples and, in reality, a configuration in which the contacted portion 28b has a shape formed only of a straight line, a configuration in which the contact portion 43c has a shape formed only of a curved line, and a configuration in which the contacted portion 28b is present on a side surface in the longitudinal direction inside the container portion 29 can also be implemented. The numbers of the contacted portion 28b and the contact portion 43c are merely examples and, in reality, a configuration in which larger numbers of the contacted portion 28b and the contact portion 43c are provided in the longitudinal direction or a configuration in which the contacted portion 28b and the contact portion 43c are only provided at one location can also be implemented.

The configuration described above which includes the developing frame having the toner chamber 27 and the crank member 41 that is a drive transmitting member and the transport member 43 inside the toner chamber 27 corresponds to a developer supplying apparatus for supplying toner to the developer container 23 in a toner transport operation to be described below.

Toner Chamber Transport Operation

Next, a transport operation by the transport member according to the present embodiment will be described. As shown in FIG. 1, the crank member 41 is rotationally driven in a direction of an arrow Q in FIG. 1 around the rotating shaft portion 41a by receiving a driving force from a main body drive motor (not illustrated) which is a drive source. At this point, toner between the rotating shaft portion 41a and the container portion 29 is subjected to stress due to rubbing.

In addition, respective parts of the transport member 43 are arranged so that the transport member 43 has a center of gravity point G further toward the one end side than the sliding portion 43b and has the free end 43d as described earlier. Therefore, when a resistance force due to the toner inside the container is to be ignored, the operation of the transport member 43 is as follows. Furthermore, hereinafter, moving toward the one end side by the transport portion 43a will be described as a forward movement and moving toward the other end side will be described as a backward movement.

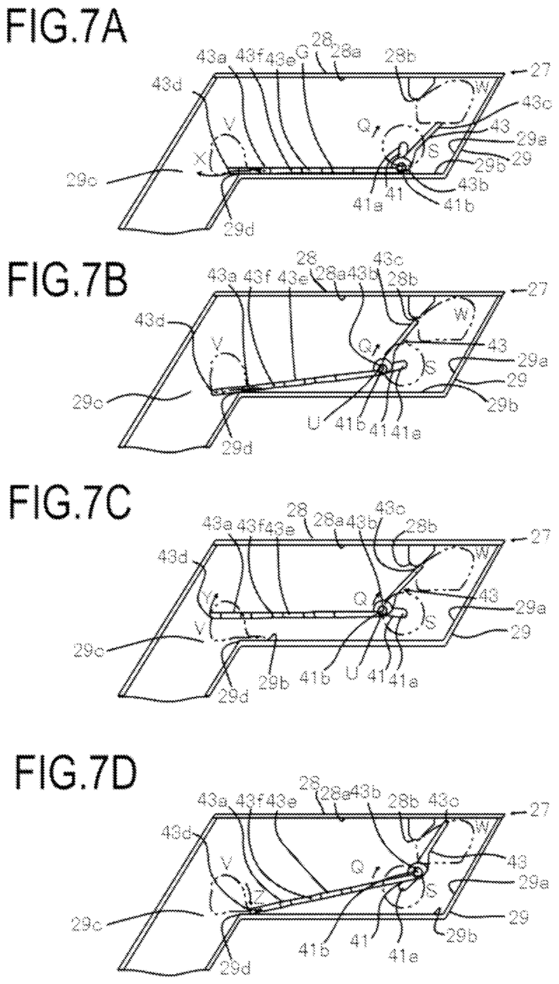

Each drawing in FIGS. 7A to 7D shows a trajectory V of the free end 43d and a trajectory W of the contact portion 43c. First, as shown in FIG. 7A, the free end 43d moves in a direction of an arrow X due to a driving force received from the crank member 41 which is a drive transmitting member. At this point, the transport portion 43a moves forward along the toner chamber bottom surface 29b and transports toner by pushing the toner toward the one end side where the opening 29c is present. In addition, during the forward movement, since the contact portion 43c passes a position lower than the contacted portion 28b, the contacted portion 28b and the contact portion 43c do not come into contact with each other.

As the crank member 41 continues to rotate from the state shown in FIG. 7A, the driven shaft portion 41b assumes a phase positioned in the vicinity of the point U closest to the one end side in the trajectory S of the driven shaft portion shown in FIG. 7B. At this point, the transport member 43 enters a state where moving from the inner side where the side surface 29a described earlier is provided toward the opening side which is the transport direction of toner hardly occurs. In this state, the contacted portion 28b and the contact portion 43c come into contact with each other and the contact portion 43c receives a reaction force due to the contact with the contacted portion 28b. The reaction force generates a lever motion with the sliding portion 43b as a fulcrum and, as shown in FIG. 7C, the transport member 43 moves backward due to a driving force of the crank member 41 while having the free end 43d being uplifted in a direction of an arrow Y.

Subsequently, as the crank member 41 continues to rotate as shown in FIG. 7D, the contact between the contacted portion 28b and the contact portion 43c is released and the free end 43d moves in a direction of an arrow Z. In other words, the transport member 43 is configured such that the sliding portion 43b coupled to the driven shaft portion 41b first follows the rotation of the driven shaft portion 41b. Accordingly, the transport portion 43a including the free end 43d moves back and forth along the toner chamber bottom surface 29b between the inner side where the side surface 29a is provided and the opening side where the opening 29c is provided. A configuration is adopted in which, when performing such a transport operation, although the free end 43d protrudes further toward the one end side than an edge portion 29d of the opening 29c at a most advanced position toward the one end side, the free end 43d is capable of reaching at least a same position as the edge portion 29d.

In the configuration described above, the transport portion 43a is capable of transporting the toner inside the toner chamber 27 until reaching the opening 29c. The toner chamber 27 supplies the toner to the developer container 23 through the opening 29c.

In a case where toner transport is performed with a configuration in which the toner is transported by a transport member having a free end on the one end side, when a toner amount inside the toner chamber decreases, a state of a toner amount and a toner surface described below is created where transport performance declines. Specifically, there is a toner amount which causes a state where toner is not discharged from the opening to be created due to the toner not reaching the opening when being moved toward the one end side during a forward movement and the toner moving toward the other end side during a backward movement.

In the present embodiment, the toner amount (a developer amount) at this point will be determined as a predetermined amount. It is assumed that the toner surface at the predetermined amount in the present embodiment is the position shown in FIG. 1.

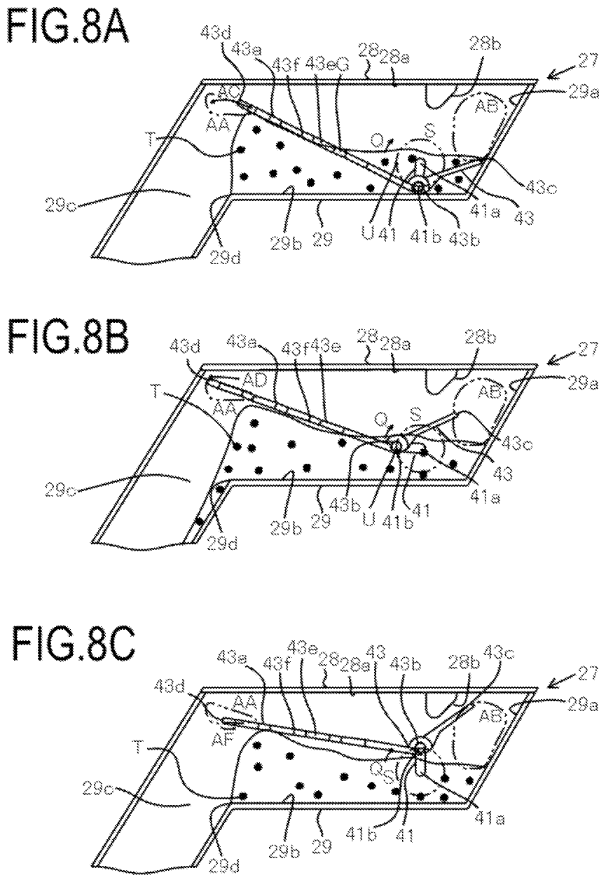

A toner transport operation by the transport portion 43a when the toner amount inside the toner chamber 27 is equal to or larger than the predetermined amount will now be described with reference to FIGS. 8A to 8C.

Each drawing in FIGS. 8A to 8C shows a trajectory AA of the free end 43d and a trajectory AB of the contact portion 43c. When the toner amount inside the toner container is equal to or larger than the predetermined amount, a downward biasing force in the vertical direction due to a self-weight of the transport member 43 is insufficient for the free end 43d to penetrate toner that is present below in the vertical direction. Therefore, as shown in FIG. 8A, the free end 43d assumes an attitude where the free end 43d is positioned above the sliding portion 43b in the vertical direction and moves in a direction of an arrow AC.

Subsequently, as the crank member 41 rotates as shown in FIG. 8B, the free end 43d moves in a direction of an arrow AD. The transport member 43 moves forward in a state where the free end 43d is positioned above in the vertical direction and performs transport by pushing toner on the one end side with the bottom surface of the transport portion 43a.

Subsequently, as the crank member 41 rotates and the driven shaft portion 41b assumes an attitude where the driven shaft portion 41b is positioned above in the vertical direction as shown in FIG. 8C, the free end 43d moves in a direction of an arrow AE. Since the present configuration is a configuration in which the contacted portion 28b and the contact portion 43c assume relative positions not in contact with each other in the phase and the attitude shown in FIG. 8C, when an amount of the toner inside the container is equal to or more than the predetermined amount, the contacted portion 28b and the contact portion 43c do not come into contact with each other during a backward movement.

As described above, the transport member 43 operates while changing attitudes due to a resistance force created by the toner.

In addition, as shown in FIG. 8A, a toner surface of the toner T in an initial state of the lifespan of the cartridge is in an upper part in the vertical direction inside the container. At this point, although the toner in the vicinity of the rotating shaft portion 41a and the driven shaft portion 41b receives stress due to rubbing, since the contacted portion 28b and the contact portion 43c do not come into contact with each other as described earlier, stress on the toner due to rubbing between the contacted portion 28b and the contact portion 43c does not occur.

Next, a toner transport operation when the toner amount inside the toner chamber 27 is equal to or smaller than the predetermined amount will be described. Supposing that an attempt is made to transport toner in a state where the toner amount inside the toner chamber 27 is equal to or smaller than the predetermined amount in a configuration in which an attitude is determined solely on the basis of the self-weight of the transport member 43 and support by the sliding portion 42b, as described above, a state is created where the toner having been transported to the one end side fails to reach the opening. Therefore, with the transport according to the configuration described above, there is a possibility that a transport amount necessary for printing cannot be secured. In order to secure a transport amount necessary for printing, toner that is moved to the other end side must be reduced to increase transport force by changing the trajectory of the transport portion 43a.

As described in the section of transport configuration, the configuration according to the present embodiment is designed so that the contacted portion 28b and the contact portion 43c come into contact with each other when the toner amount inside the toner chamber 27 is equal to or smaller than the predetermined amount and changes the trajectory of the transport portion 43a for the purpose of improving transport capability.

Therefore, the transport member 43 in a case where the toner amount inside the toner chamber 27 is equal to or smaller than the predetermined amount performs an operation similar to the operation shown in FIGS. 7A to 7D in a case where a resistance force created by the toner inside the container is ignored.

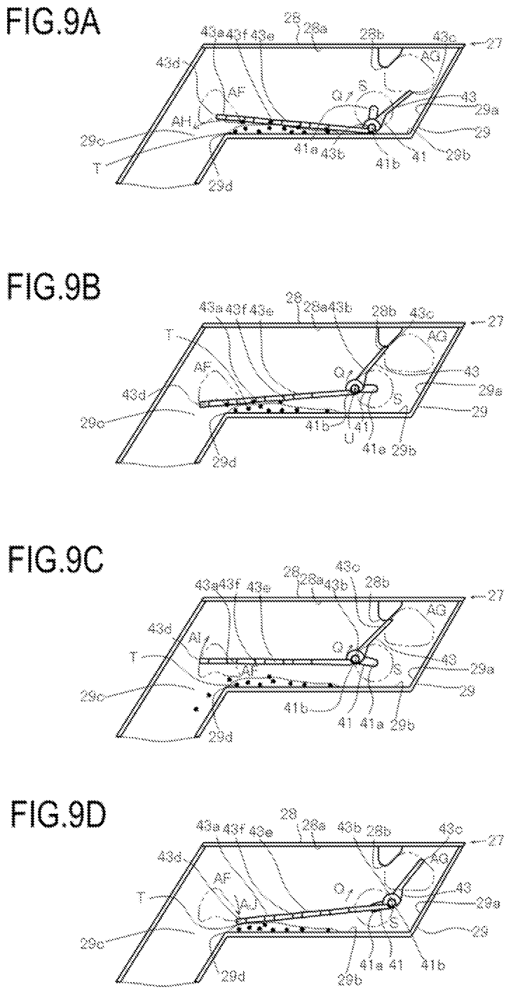

Hereinafter, a toner transport operation when the toner amount inside the toner chamber 27 is equal to or smaller than the predetermined amount in the present configuration will be described with reference to FIGS. 9A to 9D. Each drawing in FIGS. 9A to 9D shows a trajectory AF of a free end and a trajectory AG of a restricted portion.

As shown in FIG. 9A, in a phase where the driven shaft portion 41b assumes a lowermost position, the free end 43d moves in a direction of an arrow AH due to a driving force received from the crank member 41. At this point, by moving forward while being in contact with the toner surface, the transport portion 43a transports toner in the vicinity of the toner surface by pushing the toner toward the one end side using the rib 43f of the transport portion. In addition, at this point, since the contacted portion 28b passes a position lower than the contact portion 43c, the contacted portion 28b and the contact portion 43c do not come into contact with each other.

As the crank member 41 continues to rotate from the state shown in FIG. 9A and the crank member 41 assumes a phase positioned at or in the vicinity of the point U closest to the one end side shown in FIG. 9B, the contacted portion 28b and the contact portion 43c come into contact with each other. At this point, the contact portion 43c receives a reaction force due to the contact with the contacted portion 28b. The reaction force generates a lever motion with the sliding portion 43b as a fulcrum and, as shown in FIG. 9C, the transport member 43 moves backward while having the free end 43d uplifted in a direction of an arrow AI.

Subsequently, as the crank member 41 further continues to rotate as shown in FIG. 9D, the contact between the contacted portion 28b and the contact portion 43c is released and the free end 43d moves in a direction of an arrow AJ. As described above, the present configuration is a configuration in which, when the toner amount inside the toner chamber 27 is equal to or smaller than the predetermined amount, the transport member 43 is switched from moving toward the opening side where the opening 29c is present into moving toward the inner side where the side surface 29a is provided and the free end 43d is uplifted during the backward movement. Adopting such a configuration prevents toner and the transport portion 43a from coming into contact with each other or reduces pressure due to the transport portion 43a with respect to the toner. Accordingly, in the present configuration, toner movement toward the other end side which may occur in other configurations having a free end can be prevented and transportability can be improved.

In order to improve transport capability by preventing toner transport to the other end side, the free end 43d must be uplifted when the transport portion 43a moves backward. In order to satisfy this condition, as shown in FIG. 1, when the driven shaft portion 41b is in a region M further toward the one end side and above in the vertical direction with respect to the rotating shaft portion 41a, the contacted portion 28b and the contact portion 43c must come into contact with each other and cause a movement of the free end 43d in the direction of the arrow AI. In order to bias the free end 43d in the direction of the arrow AI when the drive shaft is in the region M, a lever motion in which an orientation of force changes is required. To this end, the contacted portion 28b must be able to come into contact with the contact portion 43c when the contact portion 43c is present on the other end side across the sliding portion from the free end 43d and the driven shaft portion 41b is present in the region M.

Therefore, desirably, the contacted portion 28b is positioned in a region H which is further toward the other end side than the point U closest to the one end side among points that can be assumed by the driven shaft portion 41b shown in FIG. 1 and the contact portion 43c is positioned further toward the other end side than the sliding portion 43b.

As shown in FIGS. 9A to 9D, when a remaining toner amount inside the toner chamber is equal to or smaller than the predetermined amount, a toner surface of the toner T is below in the vertical direction and on the one end side due to gravitational force and toner transport toward the one end side by a transport operation. For this reason, the toner T does not come into contact with the rotating shaft portion 41a and the sliding portion 43b. In addition, although the contacted portion 28b and the contact portion 43c come into contact with each other, the contact part is positioned above the toner surface of the toner T in the vertical direction and therefore does not come into contact with the toner T. Therefore, stress applied to the toner T in a latter half of the lifespan of the cartridge in which a major portion of the toner is biased toward the one end side can be reduced.

On the other hand, in a conventional transport configuration having a drive portion on the one end side, a state where the toner may come into contact with the sliding portion is maintained through the entire lifespan of the cartridge. From the above, in the present configuration, stress on toner can be reduced as compared to a conventional transport configuration having a drive portion on the one end side.

Therefore, in the present configuration, printing can be performed with higher image quality than a transport configuration having a drive portion on the one end side.

The driving source is not limited to directly inputting drive from a main body drive motor (not illustrated), and drive can be input via a gear train from an input portion to another driving portion. The crank member 41 is an example of a drive member, and required operations can also be performed using an eccentric cam and a linear shaft member.

Furthermore, the predetermined amount of toner varies depending on settings of conditions of a system or toner and different configurations necessitate different amounts. Therefore, the predetermined amount is not limited to the amount described in the present embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-223906, filed on Nov. 29, 2018, which is hereby incorporated by reference herein in its entirety.

What is claimed is:

1. A developer supplying apparatus, comprising:
a developing frame having an opening and a developer storage chamber which communicates with the opening and which stores a developer;
a transport member which is provided in the developer storage chamber and which transports and supplies the developer from an inner side that is distant from the opening toward an opening side that is close to the opening; and
a drive transmitting member which is connected to the transport member and which moves the transport member by transmitting a driving force to the transport member,
wherein the drive transmitting member includes:
a rotatable rotating shaft portion;
a driven shaft portion which orbits around the rotating shaft portion with the rotating shaft portion as a center of rotation; and
a connecting portion which connects the rotating shaft portion and the driven shaft portion, and
wherein the transport member includes:
a transport portion having a first end portion positioned on the opening side and a second end portion which is positioned on the inner side and which is coupled to the driven shaft portion; and
a contact portion configured such that one end thereof is coupled to the transport portion and another end thereof is capable of coming into contact with the developing frame.

2. The developer supplying apparatus according to claim 1,
wherein a contacted portion, which is contactable with the other end of the contact portion, is provided on an inner wall surface of the developing frame, and
the contacted portion is constituted by a projected portion that protrudes toward inside from the developing frame.

3. The developer supplying apparatus according to claim 2,
wherein the projected portion is provided on a top surface of the inner wall surface of the developing frame in an attitude during use.

4. The developer supplying apparatus according to claim 1,
wherein the one end of the contact portion is provided in the second end portion of the transport portion.

5. The developer supplying apparatus according to claim 1,
wherein the contact portion is integrally formed with the transport portion.

6. The developer supplying apparatus according to claim 5,
wherein the contact portion is formed at a predetermined angle with respect to the transport portion.

7. The developer supplying apparatus according to claim 1,
wherein in an attitude during use, the other end of the contact portion is positioned above the second end portion of the transport portion.

8. The developer supplying apparatus according to claim 2,
wherein the contact portion comes into contact with the contacted portion when the transport portion is switched from moving toward the opening side into moving toward the inner side.

9. The developer supplying apparatus according to claim 2,
wherein the contacted portion is arranged in a region outside a rotation locus traced by the driven shaft portion.

10. The developer supplying apparatus according to claim 2,
wherein the other end of the contact portion comes into contact with the contacted portion when an amount of the developer stored in the developer storage chamber is equal to or smaller than a predetermined amount.

11. The developer supplying apparatus according to claim 1,
wherein, in an attitude during use, the developing frame is configured so as to have an inclined surface that is continuous to a bottom surface of the developing frame on the inner side when viewed from a direction perpendicular to a transport direction of the developer that is transported from the inner side toward the opening side, and such that an angle formed between the inclined surface and the bottom surface is an obtuse angle.

12. A developing apparatus, comprising:
the developer supplying apparatus according to claim 1;
a developer bearing member for bearing a developer supplied from the developer supplying apparatus; and
a developing blade for restricting a toner layer borne on the developer bearing member.

13. A cartridge, comprising:
the developing apparatus according to claim 12; and
an image bearing member on which an electrostatic latent image is to be formed,
wherein the cartridge is attachable to and detachable from an apparatus main body of an image forming apparatus.

14. An image forming apparatus, comprising:
the cartridge according to claim 13; and
an apparatus main body to which the cartridge is attachable and from which the cartridge is detachable.
